(19) United States
(12) Patent Application Publication
(10) Pub. No.: US 2005/0227657 A1
(43) Pub. Date: Oct. 13, 2005

(54) Method and apparatus for increasing perceived interactivity in communications systems

(75) Inventors: Tomas Frankkila, Lulea (SE); Jonas Svedberg, Lulea (SE); Krister Svanbro, Lulea (SE); Bjorn Svensson, Lulea (SE); Tomas Jonsson, Lulea (SE)

Correspondence Address: NIXON & VANDERHYE, PC, 901 NORTH GLEBE ROAD, 11TH FLOOR, ARLINGTON, VA, 22203, US

(73) Assignee: Telefonaktiebolaget LM Ericsson (publ), Stockholm (SE)

(21) Appl. No.: 10/819,376

(22) Filed: Apr. 7, 2004

(51) Int. Cl. G10L 13/06

(52) U.S. Cl. 455/255

(57) ABSTRACT

Perceived interactivity in user communications is achieved by reducing a perceived delay switching the active transmitter in the communication without having to reduce actual transmission and setup delays associated with a communication exchange. A sound signal is identified in the user communication. The sound signal is analyzed to identify or estimate a sound signal segment. The sound signal segment is preferably (though not necessarily) located at the beginning or the end of the sound signal. The sound signal segment may be selected directly from the sound signal itself, from a modified version of the sound signal, or from a signal associated with the sound signal. A determination is made that a length or duration of the sound signal segment should be or can be modified. One or more modifications for the sound signal segment are determined and are provided to one or more processing units to perform the modification(s).

### RELATED APPLICATION

This application is related to commonly-assigned U.S. patent application Ser. No. 10/______, attorney docket 2380-790, entitled, “Method and Apparatus For Use In Real-Time, Interactive Radio Communications.”

### TECHNICAL FIELD

The technical field is communications. The present invention increases perceived interactivity in speech communications and is particularly advantageous to voice-over-IP communication systems. One practical, but non-limiting application is push to talk (PTT) communications.

### BACKGROUND AND SUMMARY

Currently, there is work ongoing to develop a push to talk (PTT) service for GPRS, EGPRS, W-CDMA, and other cellular communications where standardized mechanisms will be used for channel resource allocation and transmission. These mechanisms are designed for general purpose data communication to provide services that have either no or very low requirements on delay and interactivity. The original designs did not concentrate on minimizing the transmission delays. In any telephony application, a long delay is disturbing for the end users and negatively impacts on the perceived quality of the service. Current objectives and requirements for PTT services require minimal transmission delay even though PTT is half-duplex. Indeed, PTT delay requirements are nearly as demanding as full-duplex telephony.

In PTT using voice-over-IP (VoIP) over GPRS, EGPRS, W-CDMA, etc., the “mouth-to-ear” delay (from sender to receiver) for the acoustical signal will be quite long, significantly longer than for normal circuit switched telephony. End users detect this delay when the active talker switches between different users, i.e., when a user A stops talking and starts to listen awaiting a response from user B. User A will perceive the long switching delay as a low interactivity or a long response time from the other user. The main problem addressed by this invention is how to enhance the interactivity. In short, this enhanced interactivity is achieved by reducing the perceived delay and without having to reducing the actual transmission and setup delays. But before discussing this problem and the proposed solution, some background information is provided.

PTT is a service where users may be connected in either a one-to-one communication or in a group communication. Push to talk communications originated with analog walkie-talkie radios, where the users take turns in talking simply pressing a button to start transmitting. In analog walkie-talkie systems, there is usually nothing that prohibits several persons from talking at the same time. The result of a collision is that the messages are superposed on top of each other, and both messages are usually distorted beyond recovery. In digital PTT systems, for example in Nextel's PTT system, (see Nextel's web site), there is a management function called “floor control” that allows only one talker at the same time.

An overview of a digital PTT system 10 is shown in FIG. 1. User A communicating using a mobile radio 12 communicates with User B communicating using a mobile radio 14 via a radio access network 16, e.g., GPRS, EGPRS, W-CDMA, etc. The radio access network 16 includes representative example radio base station 18 communicating over the radio interface with mobile radio 12. Representative example radio base station 22 communicates over the radio interface with mobile radio 14. A PTT server 20 is coupled to both radio base stations 18 and 22 and coordinates the setup, control, and termination of PTT communications between users A and B.

An example of some basic steps involved in a PTT communication is given below for a one-to-one communication. Other steps, e.g., those needed for choosing whom to talk to, have been omitted to simplify the description.
1- User/client A wishes to send a message to User B and presses a button on the PTT client (similar to a mobile radio).
2- The PTT client A sends a request to a PTT server asking for permission to speak.
3- The PTT server decides if it should grant or reject the request and sends either a “Floor Grant” signal or a “Floor Busy” signal back to Client A.
4- Upon receiving the “Floor Grant” signal, Client A usually presents a visual or acoustical signal (lamp, LED, beep, or a short melody) to User A to indicate that User A may start talking.
5- The PTT server may also send a “Floor Taken” message to Client B to inform it that another user has taken the floor and that speech packets can be expected soon. Client B may also present a visual or acoustical signal to User B, thereby giving User B an advanced warning that a message can be expected soon.
6- Upon receiving the “Floor Grant” signal, client A starts recording the acoustical signal from the microphone and starts speech encoder processing. The speech signal is usually encoded in blocks (frames).
7- The PTT client may pack one or several encoded speech frames into a packet before transmission.
8- The packets from Client A are transmitted over the air interface to the base station and further on to the PTT server.
9- The PTT server forwards via a base station the packets to Client B over the same or different air interface.
10- Client B starts the decoder processing of the received speech frames immediately or with a small buffering delay.
11- The decoded speech frames are played to User B by the loudspeaker in Client B.

The encoding and decoding of speech frames and the transmission of packets continues as long as the transmitting user is pressing the PTT button. Other users cannot talk at the same time and must wait until the floor is released. A one-to-many communication is very similar, but with several receivers instead of only one receiver. Each step may be optimized in an attempt to reduce the delay and avoid user annoyance.

Certain signals may be used to identify useful properties of “talk bursts.” A talk burst in PTT is one or several sentences spoken from the pressing of the PTT button to releasing it. A Talk Burst Start (TBS) identifies the start of a talk burst, i.e., that a current media packet is the first packet of a new talk burst and that the receiver's speech decoder states should be reset to match the states of the speech encoder. A media packet is a packet containing the sound information, e.g, (e.g., a real time transport protocol (RTP) packet). An example way to signal a TBS is to set an RTP marker bit in the RTP header of the first packet. A Talk Burst End (TBE) identifies the end of the talk burst, e.g., a current RTP media packet is the last packet for the current talk burst. An example way to signal a TBE is to include an RTP header extension in the last packet.

In a PTT service using Voice over IP (VoIP) over cellular technologies, the setup time and the transmission delay are likely undesirably long due to a number of factors.
Encoder buffering time. To save IP/UDP/RTP header overhead, even if header compression is not used, several speech frames are packed into the same IP/UDP/RTP packet. For example, if 10 speech frames are packed into one RTP packet, and if a speech frame corresponds to 20 msec of speech, then the encoder buffering time is 200 msec.
Decoder buffering time. A jitter buffer or frame buffer is needed in the receiver to compensate for the delay jitter that occurs in packet-switched networks. A typical jitter buffer normally buffers one or a few IP packets. With 10 frames/packet and 3 packets in the jitter buffer, the decoder buffering time is 600 msec.
Channel allocation time. The data channel is usually a shared resource, and the client needs to allocate transmission capabilities before the actual transmission may start. A handshaking procedure is required with a radio network node that manages the channel allocation. This handshaking procedure typically takes on the order of a few hundred milliseconds.
Transmission and re-transmission time. Radio communications suffer from considerable errors due to the nature of the radio interface. The communication protocol therefore needs to implement error detection and error correction strategies such as channel coding, interleaving, and re-transmission (e.g., ARQ). As a result, even more information must be transmitted on already-limited radio channels. When a receiver asks for re-transmission of packets not properly received, the delay may increase up to 150-200 msec, depending on what part of the packet that was lost.
Floor-control in the PTT server. Floor control signaling is performed over the air interface which takes at least about 200-300 msec. This time will be longer if one has to wait for someone else to stop talking.
Floor-control in the client. Due to the varying delay in packet-switched networks and also due to the unreliable transmission over the radio interface, packets containing floor-control messages or talk burst signaling may be delayed or even lost. This is handled by implementing a local floor-control function in the clients, usually with a set of timers. Local floor control may add additional delay in some cases.

All these factors add up to a quite long delay, typically in the order of one or a few seconds. This is not a big problem in a single one-way communication. But in a conversation, when the active talking party transfers between different persons, a long delay is annoying. The long delay is perceived as a long “switching time” between sending speech (talking) to hearing the response from the other user.

A typical conversation between two users is illustrated in FIG. 2, and various delays are shown. User/client starts by sending a talk burst (sentence 1) to user/client B. User B takes some time to think of the answer and then responds back to user A (sentence 2). The conversation may, of course, continue with more messages (sentences), but these two sentences are sufficient to illustrate the delay effects. Consider the following different delays:
The initial delay dᵢ.

Transmission delay for sentence 1 dₜ₁. Note that dₜ₁ does not have to be exactly the same as dᵢ if, for example, some part of the sentence is recorded and buffered during the initial delay and then transmitted with a higher speed. For simplicity, we assume that dₜ₁=dᵢ in this description.
Thinking time for User B, d_{b}.
Transmission delay for sentence 2 dₜ₂.
Switching delay, dₛ, as experienced by User A.

As can be seen from FIG. 2, the switching time delay ds is:
dₛ=dₜ₁+d_{b}+dₜ₂ (Eq. 1)

Notice that the switching time delay can actually be perceived as negative in full-duplex communication, if User B interrupts User A. In this case, d_{b} is negative according to this definition. But in PTT, the switching time delay will not be less than zero if the floor control only allows one active talker at a time and thereby prohibits User B from interrupting User A.

The delay that users notice is the switching delay dₛ. Most users have, based on face-to-face and telephony communication experiences, some expectations regarding switching time delay. If the switching delay is longer than expected, users will be dissatisfied with the quality of the service, especially in cases where a fast response is expected. One example is when one user asks the other user a simple question that does not require much time to think of an appropriate response.

Theoretical analyses and practical tests have been made to estimate these delays. They have shown that the transmission delay for the first sentence, dₜ₁, may be about 3 seconds or more. For subsequent sentences, the transmission delays, dₜ₂, dₜ₃, . . . , d_{tN}, will be about 1 second, not including extra delay for re-transmissions due to channel errors. The reason for the extra delay for the first sentence is the setup time needed. This setup can be made in advance for subsequent sentences, to save some time.

Even small transmission delays, e.g., below 0.3-0.5 seconds, can be noticeable. For longer delays, e.g., up to 1-2 seconds, the perceived quality is significantly reduced, and the users may even become annoyed and irritated. Long delays, around 5-10 seconds, may even trigger additional transmissions, when one user asks the other user if he/she is still available. In severe cases, the users may start questioning if the message was forwarded correctly, or if it was lost or perhaps even if the service was disconnected.

Delay has a large impact on the perceived quality of the service, larger than most other degrading factors including speech codecs. It is therefore important to reduce the perceived delay in order to increase the perception of the interactivity level that the service can offer.

Enhanced perceived interactivity in user communication is achieved by reducing the perceived switching delay, which can be accomplished in many ways for example by reducing the transmission and setup delays. This invention shows how to do it without having to reduce the actual transmission and setup delays. First, a sound signal is identified in the user communication. The sound signal is then analyzed to identify or estimate start and end points of a sound signal segment. The sound signal segment is preferably (though not necessarily) located at the beginning or the end of the sound signal. The sound signal segment may be selected directly from the sound signal itself, from a modified version of the sound signal, or from a signal associated with the sound signal. A determination is made that a length or duration of the sound signal segment should be or can be modified. One or more modifications for the sound signal segment are determined and are provided to one or more processing units to perform the modification(s).

### BRIEF DESCRIPTION OF THE DRAWINGS

FIG. 1 illustrates an example, non-limiting PTT communications system in which the present invention may advantageous be employed;

FIG. 2 illustrates an example timing diagram showing various delays that contribute to a switching time delay;

FIGS. 3A-3D are flowchart diagrams illustrating example procedures for enhancing perceived interactivity in user communications;

FIG. 4A illustrates a non-limiting example implementation for enhancing perceived interactivity in a PTT system such as the PTT system shown in FIG. 1;

FIG. 4B illustrates a non-limiting example transmitter-only implementation for enhancing perceived interactivity in a PTT system such as the PTT system shown in FIG. 1;

FIG. 4C illustrates a non-limiting example receiver-only implementation for enhancing perceived interactivity in a PTT system such as the PTT system shown in FIG. 1;

FIG. 5 illustrates an example timing diagram showing how shortening an end of a sentence can enhance perceived interactivity in a non-limiting PTT communications context; and

FIG. 6 illustrates an example timing diagram showing how extending a beginning of a sentence can enhance perceived interactivity in a non-limiting PTT communications context.

### DETAILED DESCRIPTION

The following description sets forth specific details, such as particular embodiments, procedures, techniques, etc., for purposes of explanation and not limitation. However, it will be apparent to one skilled in the art that other embodiments may be employed that depart from these specific details. For example, although the following description is facilitated using a non-limiting example application to a PTT communications system, the invention may be employed in any voice-over-IP (VoIP) type of communication that is half-duplex, full duplex, simplex, etc. An example of simplex audio is a “chat” communication where one user sends an acoustic signal (speech) and the other user responds with a text message. And although the description is written in the context of cellular radio communications, the invention is applicable to other radio systems, (e.g., private radio systems), and both circuit-switched and packet-switched wireline telephony. Indeed, the invention may be applied to any application where modifying a part of a sound signal to enhance perceived communication interactivity is desirable.

In some instances, detailed descriptions of well-known methods, interfaces, devices, and signaling techniques are omitted so as not to obscure the description with unnecessary detail. Moreover, individual blocks are shown in some of the figures. Those skilled in the art will appreciate that the functions may be implemented using individual hardware circuits, using software programs and data in conjunction with a suitably programmed digital microprocessor or general purpose computer, using an application specific integrated circuit (ASIC), and/or using one or more digital signal processors (DSPs).

For purposes of this description, the term “sound signal” encompasses any audio signal like speech, music, silence, background noise, tones, and any combination/mixture of these. The term “sound signal segment” encompasses any portion of a sound signal including even a single sound signal sample or a single pitch period up to even the entire sound signal if desired. The term “sound signal segment” also encompasses one or more parameters that describe any portion of a sound signal. One non-limiting example of a sound signal segment could be part of audio signals like speech, music, silence, background noise, tones, or any combination. Non-limiting examples of sound signal parameters in the example context of CELP speech coding include linear predictive coding (LPC), pitch predictor lag, codebook index, gain factors, and others.

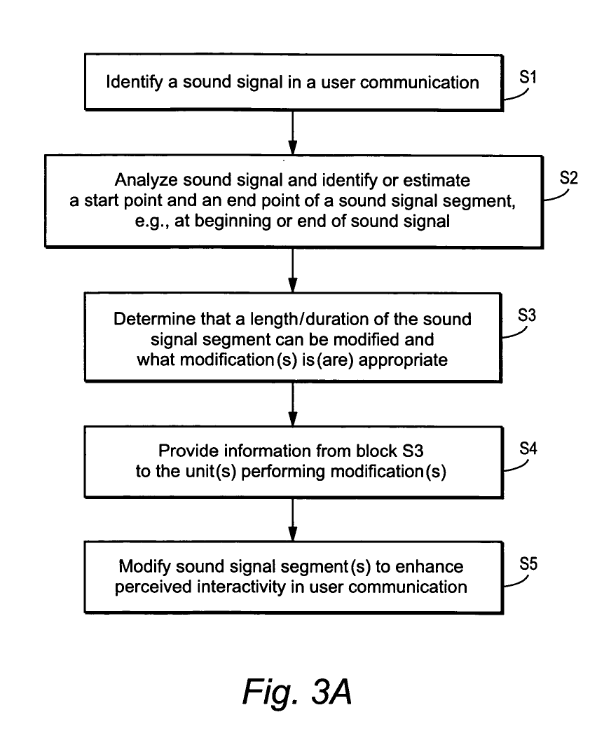

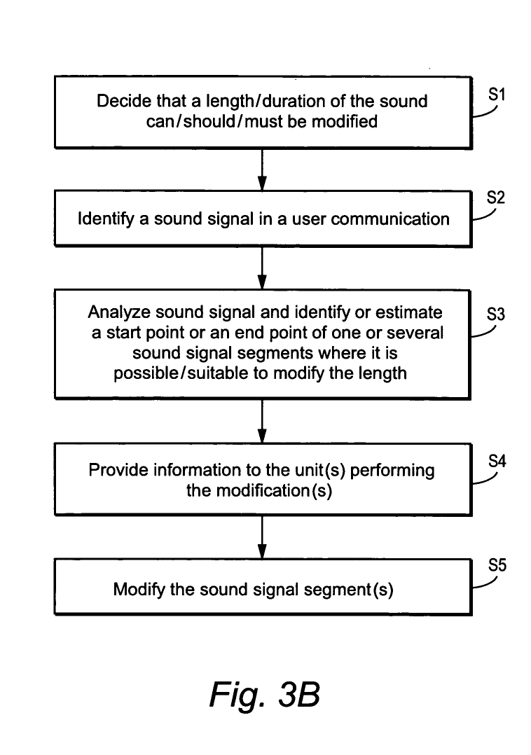

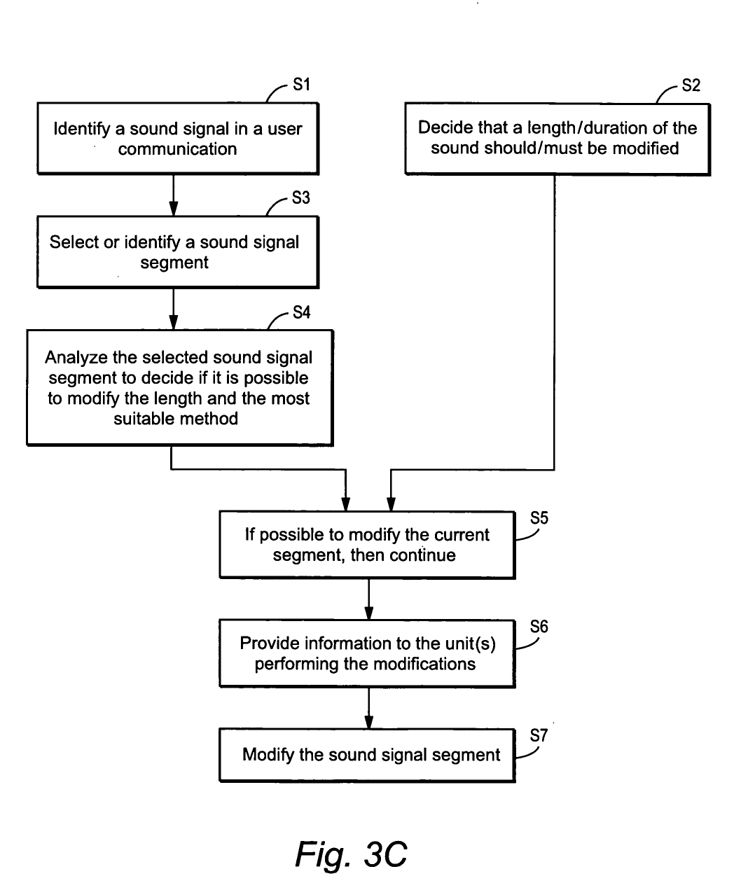

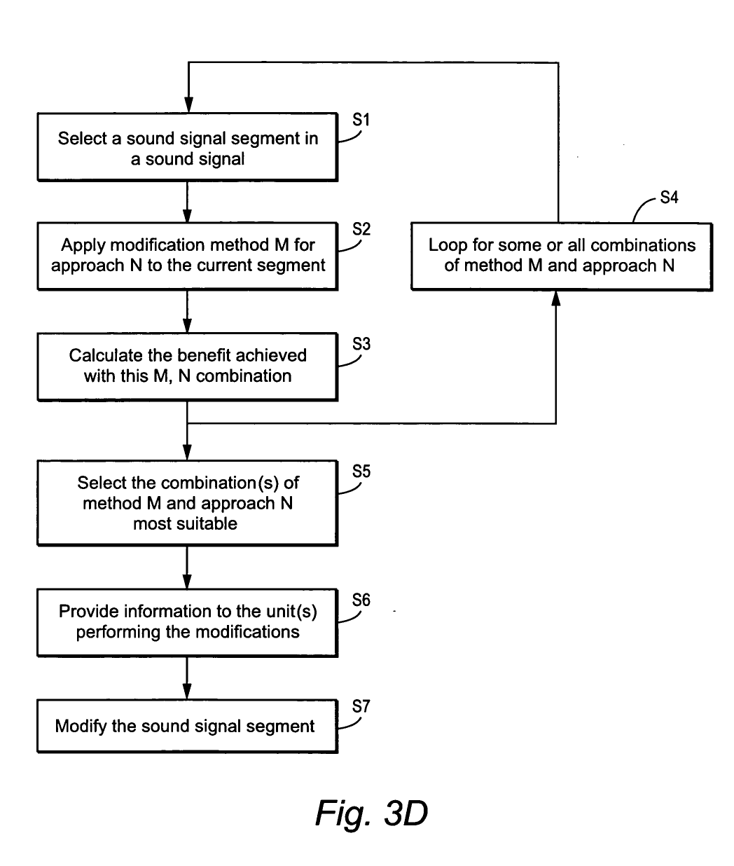

FIG. 3A is a flowchart illustrating example procedures capable of being implemented on one or more computers or other electronic circuitry for reducing a perceived delay for users involved in a communications exchange without having to reduce the actual setup and transmission delays associated with the communications exchange. A sound signal is identified in a user communication (block S1). The sound signal is analyzed to identify or estimate a sound signal segment, preferably though not necessarily, at the beginning and/or end of the sound signal (block S2). Block S2 includes selecting a segment directly from the sound signal itself, selecting a segment from a modified version of the sound signal, or selecting a segment from a signal associated with the sound signal. A determination is made that a length or duration of the sound signal segment should be or can be modified, and one or more appropriate modifications are determined (block S3).

The sound signal segment modification can be any modification, e.g., shortening, extending, deleting, adding, filtering, re-sampling, etc. If a modified version of the sound signal segment is to be modified, parameters related to the segment might be modified. In an LPC example, an LPC codec typically generates/encodes an LPC residual as a sum of two excitation vectors. One is a pitch predictor excitation vector which is normally described using a pitch predictor lag parameter (a pitch pulse interval) and a gain factor parameter. The other is a codebook excitation vector, which normally is a time-domain signal but is encoded with a codebook index, and amplified with a gain factor. Parameters that could be modified in this example include LPC residual, pitch predictor excitation vector, pitch predictor lag, pitch pulse interval, gain factor, codebook excitation vector or other codebook parameters. Other parameter variations are of course possible. As one example, the vector length may not be modified, but rather the number of samples that are used from the vectors is changed. For example, if the receiver only plays back the first half of a frame and disregards the remaining samples.

Information from block S3 is provided to one or more processing units designated to perform the modification(s) (block S4). The sound signal segment is modified to enhance perceived interactivity in the user communication (block S5). One or more modifications can be made separately or in combination with each other. The modification enhances perceived interactivity—a shorter delay—without having to reduce the actual transmission and/or setup delays. But the modification is preferably used along with actual transmission and/or setup delay reduction techniques.

The method steps shown in FIG. 3A need not be implemented in the order shown. Any appropriate order is acceptable. Indeed, two or more of the steps may be performed in parallel, if desired. FIG. 3B, for example, shows another example with method steps S1-S5 having a different order and somewhat different decision step. FIG. 3C shows steps S1-S7 where the sound signal segment selection and how to best modify the segment are parallel processes. These parallel processes may, if desired, operate more or less continuously, even if it is not decided that a segment length should be modified, to make the system more responsive if/when modifications must be made. FIG. 3D shows an analysis-by-synthesis approach in steps S1-S7. In essence, all possible variants are tried, and the best one is selected. This can also be done in a more “structured” way, for example:

Try modifying only silence and/or background noise segment(s) first. If this is not sufficient, then try modifying unvoiced segment(s). If this together with possible modifications of the silence and background noise segments is enough, then the process is done. If not, then continue with stationary voiced segment(s). If this together with the modifications of the silence and background noise and unvoiced segments is enough, then the process is done. If not, then . . . etc. The process continues with other segment types until reaching the target level on how much one should modify the length of the whole segment. A benefit of using this structured approach is that length modifications are “easier” to apply to some segment types than to other segment types. “Easier” here means largest possible modification with least possible sound quality degradation. Again, the method step order for this structured approach is only an example and can be altered.

A practical consideration for using this structured approach depends on the segment length in relation to the length of the whole talk burst/sentence. For real-time telephony, where there are very little look-ahead and where the buffers are small, it may not be possible to do this. But in PTT, the buffering may be longer and the transmission and setup delays are typically longer making this structured approach more attractive because there is more sound to work with.

The above example approaches illustrate in a non-limiting way the flexibility in implementation for the present invention. The order of method steps is not set or otherwise critical. In any method, length modifications are made in a controlled way to minimize any distortions because abruptly “chopping” the sound creates substantial, undesired distortions.

The following describes various example, non-limiting ways to reduce the perceived delay for users involved in a communications exchange without having to reducing the actual setup and transmission delays associated with the communications exchange. Other techniques, implementations, and embodiments may be employed that accomplish this objective. In general, the length or duration of the sound signal segment is modified before it is played to the listening user. The segment chosen to be modified is usually (but not necessarily) shorter than the sound signal, and the modification is usually (but not necessarily) made to a portion of the segment, e.g., one sample or a group of samples. For example, a suitable portion that could be inserted or removed during voiced speech is a whole pitch period (usually 20-140 samples at 8 kHz sampling rate). During noise, a suitable portion that could be inserted or removed may be several hundreds of milli-seconds up to seconds.

Several example methods described below may be used to shorten the end of a sound signal segment or extend the beginning of the sound signal segment. Other methods may be used, and other locations within the sound signal segment may be modified. By shortening the end of the sound signal segment, the receiving user notices earlier that the sound signal, such as a sentence, has ended, which permits the receiving user to respond earlier. By extending a sound signal segment in the beginning of the sound signal, the receiving user will notice earlier that a message is being received, even if only background noise is added (or inserted).

Consider the following non-limiting examples. If the sound signal is “Should we go to the movie soon?”, then a suitable modification could be to shorten the long “o” sound in “soon” and any silence period after the question mark. If the sound signal is “Should we go to the movie soon? I'm ready in 5 minutes,” then the small pause between “ . . . soon?” and “I'm . . . ” might selected to be reduced.

In most cases, better results are achieved if the modification method is tailored for the type of signal, e.g., voiced speech, unvoiced speech, silence, background noise, etc. Typically all words have one or several “voiced segments”, “unvoiced segments,” and “onsets.” And in-between the words, there are usually short periods of “silence” or “background noise.” A “voiced” segment is a sound with a “pitch,” and pitch is created when the vocal cords are used. An “unvoiced” segment includes sounds when the vocal cords are not used. In the word “segment,” for example, the “e” sounds are voiced, and “s”, “g”, “m”, “n” and “t” are unvoiced. Speech sounds like voiced, unvoiced, and onsets are produced by a human person, while silence and background noise are typically created by the surrounding environment.

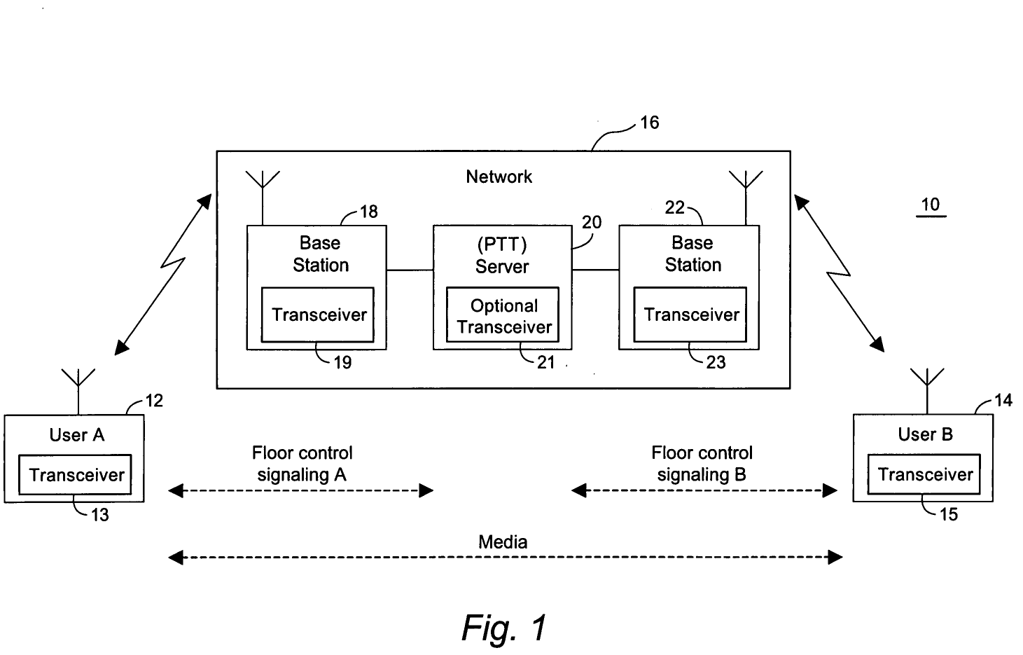

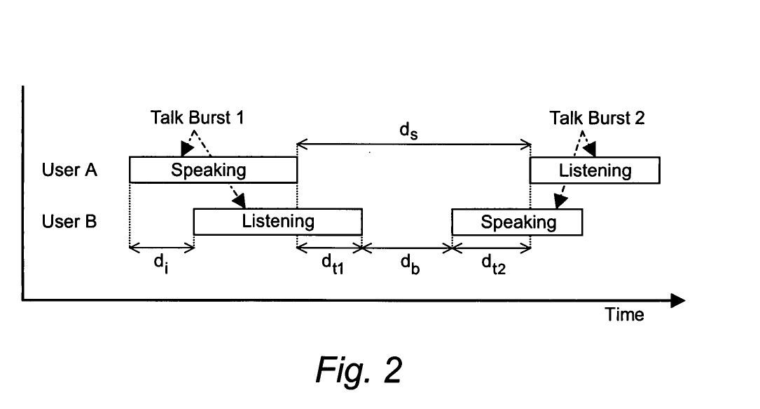

The implementations described below are mainly designed to work in the user communication terminals or “clients” since they already have speech encoding and decoding capabilities. Although many network servers do not perform speech encoding and decoding, the invention may be implemented in a server, like the PTT server in FIG. 1, if the server can perform speech encoding and decoding. The following implementations are described only for purposes of illustration in a PTT-based context, which is half-duplex. But the principles work equally well for full-duplex (two-way) conversations, except that there is no PTT button that indicates the start or the end of the talk bursts. A sound signal, for the following PTT example only, corresponds to one sentence spoken by one user, typically from the time the PTT button is pressed to its release. The examples below show communication between two persons, but they work equally well for group communication.

Referring again to the example VoIP system used for PTT shown in FIG. 1, the mobile radio 12 includes a transceiver 13 and control circuitry, the mobile radio 14 includes a transceiver 15 and control circuitry, both base stations 18 and 22 include a respective transceiver 19, 23 and control circuitry, and the PTT server 20 may optionally include a transceiver 15 and control circuitry depending on the system design, services, and/or objectives.

As one non-limiting application of FIG. 3 applied to the PTT communications system shown in FIG. 1, the following steps may be performed (not necessarily in this order and some steps may be performed in parallel).
1- Perform an analysis, based on the sound signal, to find the beginning or the end of the sound signal, to estimate the likelihood that the sound signal will start or the end is likely, to estimate the likelihood that the start or the end is not likely, or a combination of these estimates.
2- Based on the analysis in step 1, decide if the end of the sound signal can and should be shortened, or if the beginning of the signal can and should be extended. Decide what type of actions that are suitable. Determine an exact modification location in the sound signal using sample number or frame number.
3- Provide the information from step 2 to the unit(s) that will apply the modification(s) to the sound signal.
4- Apply the modification(s) to the sound signal and produce the modified signal to the listening user. This step may include modifying or overriding the decision taken in step 2, depending on the characteristics of the channel or the network which was used for transmitting the media packets.

Modifications to the sound signal can be implemented in different ways. One way is a transmitter-only, speech encoder-based configuration. All the steps above are made in the transmitter, and the modifications to the sound signal are made before transmitting the encoded sound information. Another way is a receiver-only, speech decoder-based configuration. All the steps above are made in the receiver, and the modifications to the sound signal are made after receiving the encoded sound information. An advantage with the transmitter-only or receiver-only implementations is backwards compatibility with unmodified clients.

A third approach is a distributed configuration. Steps 1 and 2 may be performed in the transmitter before transmitting the encoded sound information, and step 4 may be performed in the receiver after receiving the encoded sound information. Step 3 may be performed using the same channel or network as is used for the media packets. The distributed configuration may include repeating steps 1 and/or 2 in the receiver.

The distributed configuration may be preferred because the encoder has better knowledge about the original signal and the decoder has knowledge about any transmission characteristics. It has the original signal which is not distorted by the encoding process. The encoder may also have access to a larger portion of the signal if several speech frames are packed into packets before transmitting the packets to the receiver. Many speech coders also have a look-ahead capability which is used in the encoder processing. Moreover, the decoder has knowledge about the delay jitter, which may have an impact on how aggressively the modifications can be made.

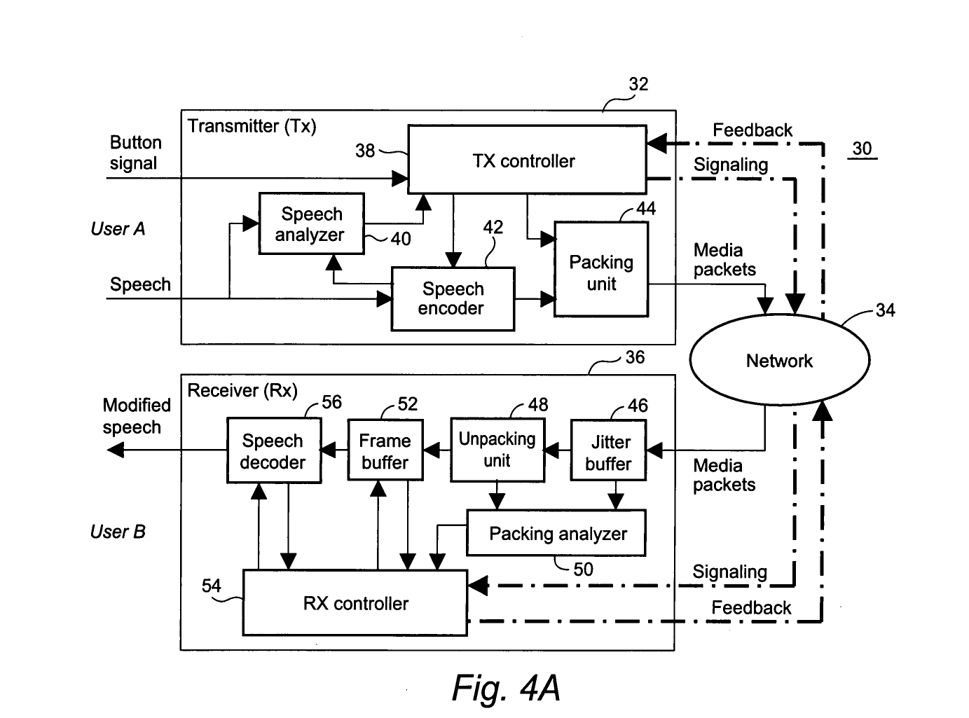

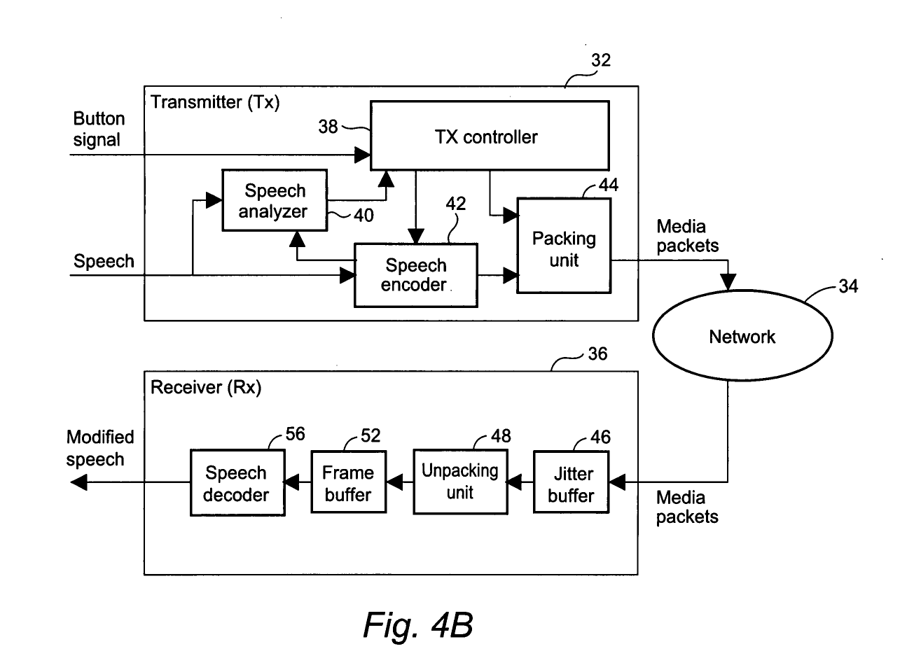

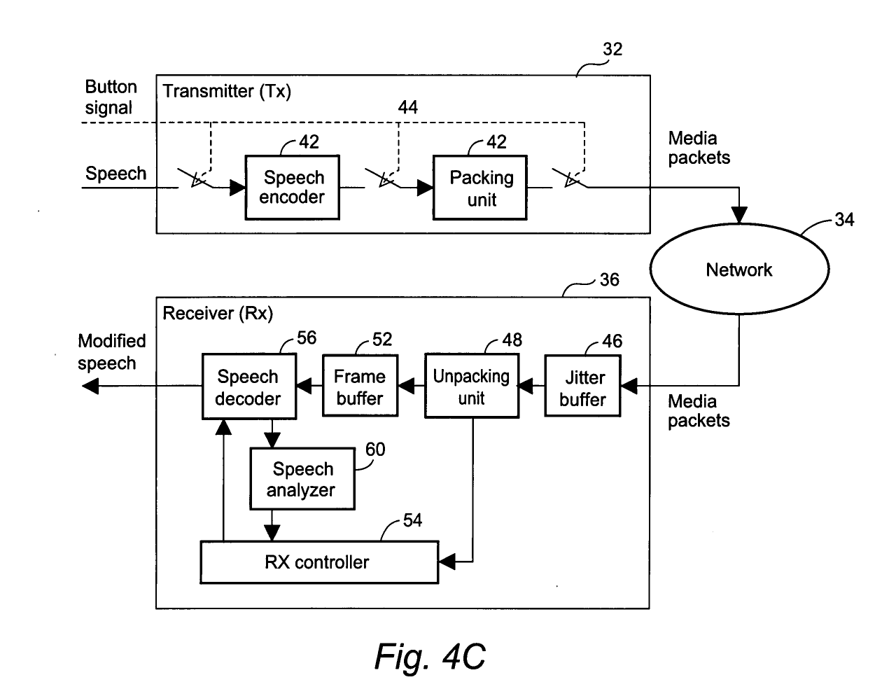

Referring now to FIG. 4A which carries on with the non-limiting PTT example, each transceiver 30 includes a transmitter 32 and a receiver 36. In the example shown in FIG. 4A, the transmitter 32 belongs to User A sending a sound signal to User B, and the receiver 36 belongs to User B receiving the sound signal from User A. The transmitter 32 is coupled to the receiver 36 by way of a suitable network 34. One example network is the radio access network 16 shown in FIG. 1. In this example, the sound signal is labeled as speech which is transformed into and transferred using media packets. Control signaling is separately shown as a dot-dash-dot line.

User A's radio terminal sends a button signal to the transmitter controller 38 to switch the transmitter 32 on or off. The TX controller also controls/manages how the speech encoder and packetizer work, e.g., if any modifications are applied and if any signaling is added as in-band signaling. Media packets are only generated as long as the button is pressed. The button signal is not present in normal full-duplex communication, but a similar signal can be generated from a Voice Activity Detector (VAD) provided in the transmitter. The speech encoder 42 compresses the sound signal to reduce the required network resources needed for the transmission. An example of a speech codec is an AMR codec where the sound signal is processed in frames of 20 msec, and the signal is compressed from 64 kbit/s (8 kHz sampling, 8-bit μ-law, or A-law) to between 4.75 and 12.2 kbit/s. The speech encoder 42 preferably has a Voice Activity Detector (VAD) to detect if there is speech in the sound signal. If the signal contains only background noise or silence, then the speech encoder 42 switches from speech coding to background noise coding and starts producing Silence Descriptor (SID) frames instead of normal speech data frames. The characteristics of background noise vary slowly, much slower than for speech. This property is used to only periodically send a SID frame, e.g., in AMR, a SID frame is sent every 160th msec. This significantly reduces the required network resources during background noise segments. Additionally, the length of the background noise can easily be increased or decreased without any performance degradation. The parameters in the SID frame usually only describe the spectrum and the energy level of the background noise and not any individual samples. There are other speech coder standards that generate a continuous stream of SID frames (comfort noise frames) such as the CDMA2000 codec specifications IS-127, IS-733, and IS-893. For these codecs, the comfort noise is encoded with a very low bit rate transmitted as a continuous stream, instead of sending a discontinuous stream.

Several speech frames may be packed together into an IP/UDP/RTP-packet (a media packet) before transmission. The IP, UDP, and RTP headers are a substantial part of the whole packet if header compression is not used. In IP/UDP/RTP, the packing unit 44 constructs the RTP, UDP, and IP packets. The packing unit 44 may be divided into several packing units, for example, one for RTP, one for UDP, and one for IP. In the construction of RTP packets, packing unit 44 sets the marker bit and a time stamp value in the RTP header. The marker bit is usually set to 1 for onset frames, when the sound changes from silence or background noise to speech, to signal suitable locations in the media stream where buffer adaptation is especially suitable. Network nodes may use this bit to reset buffers. The time stamp corresponds to the time for the first sound sample of the encoded sound signal in the current RTP packet. The length of the encoded sound signal (in number of samples) is used to increment the time stamp to the subsequent RTP packet. For example, if 10 frames of 160 samples (=20 msec) are packed together in each RTP packet, then the time stamp is incremented with 10*160=1600 for each RTP packet. The speech encoder 42 and packing unit 44 are controlled by the transmitter controller 38, which itself is controlled by the speech analyzer 40.

At the receiver 36, the received packets are first stored in a jitter buffer 46 before unpacking them. The packets arrive to the jitter buffer 46 at irregular intervals due to transmission delay jitter. The jitter buffer 46 equalizes the delay jitter so that the speech decoder 56 receives the speech frames at a regular interval, for example, every 20 msec. The jitter buffer 46 may incorporate an adaptation mechanism that tries to keep the buffer level (number of packets in the buffer) more or less constant. SID frames may be added or removed in the jitter buffer (or in the frame buffer) when detecting an RTP packet with the marker bit set indicating the start of a talk burst. The jitter buffer 46 is optional if a frame buffer 52 is used.

The unpacking unit 48 unpacks the received packets into speech frames and removes the IP, UDP, and RTP headers. The unpacking unit 48 may be a part of the jitter buffer 46 or the frame buffer 52. If several speech frames are packed into the same media packet, it is useful to have a frame buffer 52 instead of a jitter buffer 46. The frame buffer functionality is similar to that of the jitter buffer, including the adaptation mechanism, except that it works with speech frames instead of RTP packets. The advantage with using a frame buffer instead of a jitter buffer is increased resolution—if several speech frames are packed into the same packet. The frame buffer 52 is optional if a jitter buffer 46 is used. The frame buffer 52 may also be integrated in a jitter buffer 46.

The speech decoder 56 generates the sound signal from the media packets. Comfort Noise Generation (CNG) is generated by the speech decoder 56 during silence or background noise periods when SID frames are received only every N^{th} frame. CNG creates, for each speech frame interval, a random excitation vector. The excitation vector is filtered with the spectrum parameters and a gain factor included in the SID frame to produce a sound signal that sounds similar to the original background noise. The received SID frame parameters are usually interpolated from a previously-received SID frame to avoid discontinuities in the spectrum and in the sound level.

The speech decoder 56 and any frame buffer 52 are controlled by control signaling received via the network 34 and by the receiver controller 54. The receiver controller 54 may use information from the packing analyzer 50 if signaling is integrated in the media packets. The packing analyzer 50 also receives information from the unpacking unit 48 and the jitter buffer 46.

The speech analyzer 40 determines the nature of the sound signal, either based on the speech signal or on parameters derived from the speech signal. For example, the speech analyzer 40 determines if a speech segment is voiced, unvoiced, noise, or silence; is stationary (when the sound does not change (or does not change considerably) from frame to frame) or non-stationary (when there are (considerable) changes); is increasing in volume or fading out; or if it contains a speech onset (going from background noise to speech). These properties are used to find suitable locations in the sound signal for a modification.

An alternative is for the speech analyzer 40 to estimate likelihood characteristics. For example, most sentences end with a fade-out period. Therefore, the likelihood of a sentence ending is high during such parts of the signal. This property can be used to shorten the sound signal even before the PTT button has been released. The opposite likelihood can also be estimated, i.e., that the sentence will continue for some time. This likelihood is high for speech onset segments and for stationary voice segments since these segments will normally be followed by more speech segments and not by silence or background noise.

The speech analyzer 40 may be integrated in the speech encoder or may be a separate function as shown in FIG. 4A. A speech analyzer, similar to the speech analyzer 40 in the transmitter 32, may be needed in the receiver 36 if a receiver-only solution is used.

The transmitter controller 38, in addition to managing overall functionality in the transmitter 32, also decides if the sound signal should be extended or shortened, and where in the signal a modification should be applied. The modification decision may be based on the type of sound signal determined in the speech analyzer 40, and possibly also optionally on the PTT button signal if the communication is a PTT communication. The transmitter controller 38 may also use the corresponding signals from the return path, i.e., in the received speech signal. Typically, client B will send some feedback information (for example delay, delay jitter, packet loss) to client A, while client A is sending media packets. This feedback information may be used in client A when modifying the sound signal.

For the modifications of the sound signal to be performed in the transmitter 32, the transmitter controller 38 sends commands to the packing unit 44 and/or the speech encoder 42. For the modifications of the sound signal that should be performed in the receiver, the transmitter controller 38 sends signals over the network to the receiver controller 54. The transmitter controller 38 is not needed in a receiver-only implementation.

The speech encoder 42 may apply sample-based modifications as decided by the transmitter controller 38. Examples include modification approaches one, three, four, and five described below. The length of the sound signal can be modified before encoding, in which case, the modifications would be performed in the speech encoder 42 or in a separate unit before the speech encoder 42. As a result, the modifications can be made on sample basis and not on whole frames, as would be the case if the modifications would be performed in the packing unit 44. This approach is especially useful in a transmitter-only implementation.

The packing unit 44 applies frame or packet-based modifications as decided by the transmitter controller 38. Examples include disgarding or adding SID frames and disregarding or adding NO_DATA frames (a NO_DATA frame is a frame with no speech data, and is for example, used if the frame has been “stolen” for system signaling). The packing unit 44 also adds the signaling that is integrated in the media packet, such as changing the packetizing (the number of frames per packet) if in-band implicit signaling is used, or adding RTP header extensions. The signaling from the transmitter to the receiver may be done in three ways: out-of-band explicit signaling, in-band explicit signaling, and in-band implicit signaling. For explicit out-of-band signaling, signaling is transmitted separately from the media. As a non-limiting example in RTP, a RTCP packet may be sent. For explicit in-band signaling, a field in the media packet may be used. As a non-limiting RTP example, the marker bit may be set or a header extension added. For implicit in-band signaling, the signal is transmitted by changing the packetizing, i.e. the number of frames that are transmitted in one packet, instead of having a constant packing rate. The unpacking unit 48 finds and extracts the in-band explicit signaling, if used, and sends it to the RX control unit. The packing analyzer 50 in the receiver 36 analyzes received packets to detect any in-band implicit signaling, for example, if variable packetizing is used.

The receiver controller 54 manages the sound signal modifications in the receiver 36. Based on signaling from the transmitter 32, either directly or via the packing analyzer 50, and possibly also based on an estimation of the delay, delay jitter and packet loss, the receiver controller 54 decides if the sound signal should be modified and decides on appropriate modification(s). The receiver controller 54 may also base its decision on the result of a speech analysis similar to the analysis described above for the transmitter 32 but performed in the receiver. This analysis may be based either on the decoded speech or on the received speech coder parameters. The receiver controller 54 is not needed in a transmitter-only implementation.

The speech decoder 56 applies the sample-based modifications as decided by the receiver controller 54. The length of the sound signal can be modified after decoding, in which case, the modification would be performed in the speech decoder 56 or in a separate unit after the speech decoder 56. As a result, the modification can be made on a sample basis and not on whole frames as would be the case if the modification as performed in the unpacking unit 48.

FIG. 4B shows one non-limiting example of a transmitter-only implementation. In this case, the speech is modified in the speech encoder 42. FIG. 4C shows one non-limiting example of a receiver-only implementation. A speech analyzer 60 is shown in this case coupled between the speech decoder 56 and the receiver (RX) controller 54. Some information in the RTP header, such as the marker bit, may be useful in the management of the modifications. If such header information is used, then the unpacking unit 48 extracts and sends it to the RX controller 54. The same header information may also be extracted by the jitter buffer 46 (not shown).

Several methods may be used to shorten or extend a sound signal. For very small and rare modifications, it is possible to simply add or remove samples in the sound signal. Although this first example modification approach is possible for small and rare modifications, more extensive modifications using this method would create noticeable distortions. A better way to implement this first approach is to add or remove samples in the LPC residual before generating the synthesized signal. This can be done with good quality during silence and background noise and with only relatively small distortions during unvoiced speech. For voiced speech segments, extensive modifications using this method are usually not preferred, since the pitch frequency would be altered which is easily detectable by the listener. Another drawback is that the modification must be quite small to avoid distortions. Distortion becomes noticeable even if only a few samples are removed or added per second. For a PTT application, these sound signal segment modifications only give a marginal effect since the sentences are often quite short, e.g., 5-10 seconds.

A second example modification approach is to shorten or extend silence or background noise segments by adding or removing comfort noise packets in the jitter buffer 46 or in the frame buffer 52. Packets in the jitter buffer, or frames in the frame buffer 52, are added or removed at the frame before the speech onset frame, before the frames are decoded. At the speech onset, the jitter buffer level (number of packets currently in the jitter buffer 46) is analyzed. If the level is below the target level, then comfort noise packets are added to fill the buffer up to the desired level. If the level is above the target level, then packets are removed from the jitter buffer 46 to get down to the desired level. Similarly, comfort noise frames can be added and removed in the frame buffer 52. To assist in this operation, the speech encoder 42 preferably sets the Marker Bit in an RTP packet header for the onset speech frame to signal that the current frame is the start of a speech burst and that the preceding frames contained only silence or background noise. The receiver (and any intermediate system nodes) may use this information to decide when to perform delay adaptation.

The packets that are added or removed contain either silence or background noise samples. Alternatively, those packets contain speech coder parameters that describe the silence (SID frames) and that can be decoded into a silence or background noise signal. This second modification method works well when the voice activity factor (VAF) is not too high, e.g., up to 50-70%, i.e., when there are sufficient silence periods between consecutive speech bursts. For PTT, a high voice activity factor can be expected, e.g., up to 90-100%, since the users are expected to be talking most of the time when they are pressing the button and will release the button when they are done. As a result, the silence and background noise periods will be few and short, which gives little room for modifications.

An alternative to adding or removing comfort noise packets is to extend or shorten the sound signal generated from the SID frames (a third example modification approach). A SID frame may only be transmitted, for example, every 24^{th} frame. The SID frame contains information about the energy of the signal, typically a gain parameter, and the shape of the frequency spectrum, typically in the form of LPC filter coefficients. The comfort noise is generated in the receiver by creating a random excitation signal, by filtering the excitation signal with the spectrum parameters, and by using the gain parameter. With the SID frames, it is easy to shorten or extend the synthesized signal by simply creating a shorter or longer random excitation signal, which is then filtered through the LPC synthesis filter. If SID frames are not used, then the corresponding parameters can usually be estimated from the synthesized sound signal at the receiving end, and then a similar SID synthesis method can be used. Similar to the second example modification method just described above, this third method works better when the voice activity factor is not too high.

A fourth example modification approach is to shorten or extend voiced segments. For larger modifications, it is possible during voiced speech to add or remove pitch periods with good quality. For PTT, this is a suitable modification method and may be used frequently if desired during voiced segments.

A fifth example modification approach is to shorten or extend unvoiced segments. For unvoiced segments, it is possible to add or remove LPC residual samples before the synthesis through the LPC synthesis filter. The fifth approach is quite similar to the first and the third approach used for background noise. But in this case, the parameters used for generating the excitation signal are transmitted from the encoder to the decoder for every frame, and the excitation does not need to be randomized.

The following are non-limiting examples of shortening a sound signal segment in an example PTT context. These examples may be used to shorten any portion of the sound signal segment.
1- Reducing the play-out time for voiced segments in the synthesized speech signal in the speech decoder. The fourth example modification approach may be used.
2- Reducing the length of voiced segments before encoding it in the speech encoder. The fourth example modification approach may be used.
3- Reducing the play-out time for unvoiced segments in the synthesized speech signal in the speech decoder. The fifth example modification approach may be used.
4- Reducing the length of unvoiced segments before encoding it in the speech encoder. The fifth example modification approach may be used.
5- Shortening or removing silence or background noise segments/frames before encoding. The third example modification approach may be used.
6- Shortening or removing silence or background noise frames (SID frames) after encoding in the encoder. The second example modification approach may be used.
7- Shortening or removing silence and background noise frames (SID frames) in the decoder before decoding. The second example modification approach may be used.
8- Shortening or removing silence and background noise segments/frames in the speech decoder after decoding. The third example modification approach may be used.

For methods 1 and 3, one usually does not know if the signal is voiced or unvoiced so the signal must be decoded first. For actions 6 and 7, the SID frames are usually uniquely-identified with a different frame type identifier or a different bit allocation, which makes it easy to know if the frame is a SID frame. These methods can be used when the end of the sentence has been detected and when there is a high likelihood that the sentence will end soon, for example when the speech signal is fading out, usually during unvoiced speech. They may be less useful immediately after a speech onset or during voiced speech segments, when the start of a subsequent sentence has been detected, for example when there is only a short pause between two sentences, or when there is a non-speech signal, for example music-on-hold.

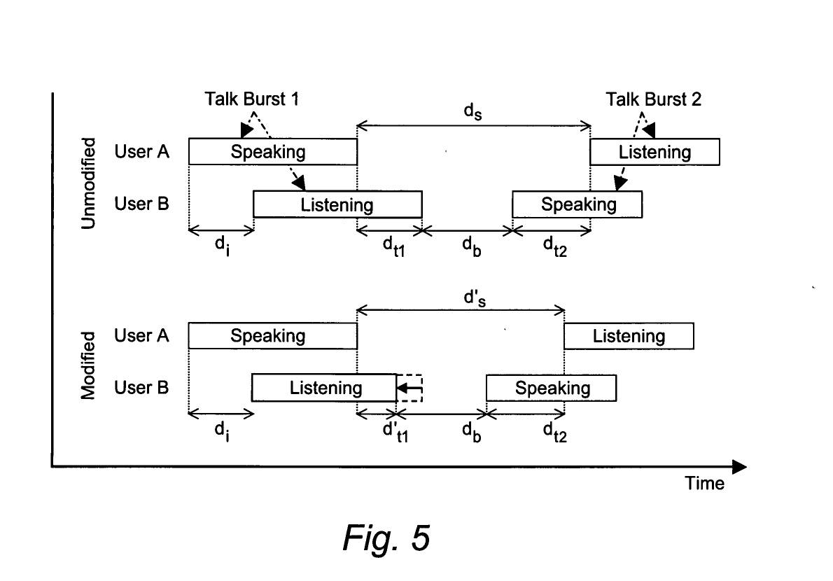

An example showing the effect on the sound signal and on the interactivity between users is provided in FIG. 5 where the end of sentence 1 is shortened in the receiver. Due to the packing of several frames into one RTP packet and due to delay jitter, there may be many frames left in the jitter/frame buffer in the receiver when user A releases the PTT button and when the receiver receives the signal that the end of the sentence has been detected or is imminent.

The following are non-limiting examples of extending a sound signal segment in an example PTT context. These examples may be used to extend any portion of the sound signal segment.
1- Start the recording of the sound signal before receiving the Floor Grant signal. Encode the background noise and send a SID frame immediately after receiving the Floor grant signal. The receiver can then start generating noise until the first speech packet is received.
2- The receiver may start generating noise immediately even without knowing the exact noise at the transmitter. In this case, previously-received SID frames can be reused, or the background noise can be estimated from previously-received speech frames. Noise could even be generated without any prior knowledge.
3- The extension may also be done with a pre-recorded (stored) sound signal or parameters for a pre-recorded (stored) sound signal.

These methods can be used when the start of the sentence has been detected, for example when the transmitter has sent an explicit signal informing the receiver that the speech has started, after receiving a Floor Taken signal from the PTT server, without receiving any media packets from the transmitter, and in-between sentences, when the pauses need to be extended. These methods may be less suitable when a PTT button has been pressed but released before receiving the Floor Grant signal, before receiving the Floor Taken signal, since one does not know that a sentence will come, in the middle of a speech signal, for example during a voiced segment, when a totally different sound would be annoying, when the start of a subsequent sentence has been detected, for example when there is only a short pause between two sentences, and when the pause should not be extended, and when there is a non-speech signal, for example music-on-hold.

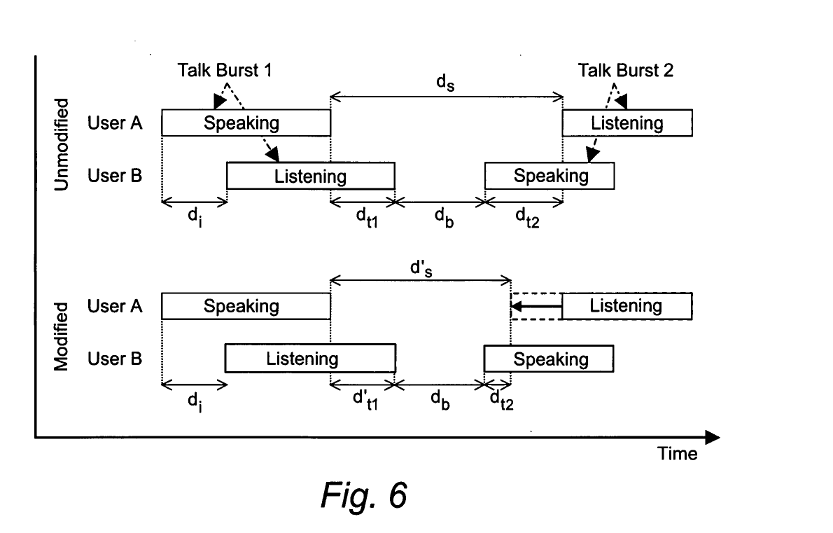

An example showing the effect on the sound signal and on the interactivity between users is provided in FIG. 6 where the start of sentence 2 is extended at the receiver. This extension can also be made for the first sentence.

As earlier indicated, the invention may be implemented in a server such as a PTT server if the server has speech encoding and decoding capabilities needed to apply modifications to the sound signal. One example might be where speech coding capabilities have to be implemented in the server because it is used for different cellular systems with different speech codecs. But even if the server does not have these capabilities, the server may still add or remove IP/UDP/RTP packets. The server may also re-pack and distribute the speech frames in more packets or may merge packets into fewer packets which permits the server to add or remove SID and NO_DATA frames.

By enhancing the perceived interactivity of a user communication, users are likely to be more satisfied with the service. This benefit is achieved without having to reduce any actual transmission and setup delays in the communications. There are also ancillary benefits. For example, extending the beginning of a sentence can also be used to build up some margin for delay jitter. The invention may be implemented entirely in the clients, in which case there is no impact on any network nodes. Even if the invention is implemented in a server, the implementation effort is limited to the server and backward compatibility for base stations and other system nodes is maintained. If implemented only in the transmitter or the receiver, backward compatibility between different clients is also maintained.

While practical and preferred embodiments have been described, it is to be understood that the invention is not to be limited to any disclosed embodiment, but on the contrary, is intended to cover various modifications and equivalent arrangements included within the scope of the appended claims.

1. A method of enhancing perceived interactivity in a user communication including one or more sound signals, comprising:
identifying a sound signal in the user communication;
determining a sound signal segment based on the identified sound signal;
determining that a length of the sound signal segment in the user communication should be modified; and
modifying a part of the sound signal segment to enhance the perceived interactivity in the user communication.

2. The method in claim 1, wherein the sound signal segment is based on a part of the identified sound signal, a modified version of the identified sound signal, or a signal associated with the identified sound signal.

3. The method in claim 1, wherein the sound signal segment includes one or more samples of a part of the sound signal or one or more parameters that describe a part of the sound signal.

4. The method in claim 1, wherein the sound signal includes a speech signal, a period of silence in the user communication, or background noise.

5. The method in claim 4, wherein a speech sound signal may be word, a sentence, or plural sentences.

6. The method in claim 4, wherein the user communication is a push-to-talk (PTT) communication and a speech sound signal in the PTT communication is the sound signal received from initiating a PTT communication to ending the PTT communication.

7. The method in claim 1, wherein the modifying includes modifying a length or duration of the sound signal segment.

8. The method in claim 1, wherein the modifying includes removing a portion of the sound signal segment, inserting a sound portion into the sound signal segment, or both removing a portion of the sound signal segment and inserting a sound portion into the sound signal segment.

9. The method in claim 1, wherein the modifying includes shortening the sound signal segment, lengthening the sound signal segment, or both shortening and lengthening the sound signal segment.

10. The method in claim 1, wherein the modifying includes adding sound signal samples, removing sound signal samples, or both adding and removing sound signal samples.

11. The method in claim 1, wherein the sound signal is compressed and the modifying includes modifying a length of a compressor residual.

12. The method in claim 11, wherein the sound signal is compressed using a linear predictive coding (LPC) algorithm and wherein the modifying includes adding LPC residual samples, removing LPC residual samples, or both adding and removing LPC residual samples.

13. The method in claim 1, wherein the modifying includes modifying a length or duration of silence or background noise in the sound signal segment by adding or removing comfort noise or by doing both.

14. The method in claim 1, wherein the modifying includes modifying a length or duration of a sound signal segment generated from a silence descriptor (SID) frame.

15. The method in claim 1, wherein the modifying includes adding pitch periods, removing pitch periods, or both adding and removing pitch periods.

16. The method in claim 1, wherein the modifying includes shortening an end of the sound signal segment by reducing a playout time of the sound signal segment.

17. The method in claim 1, wherein the modifying includes shortening an end of the sound signal segment by reducing a length of the sound signal segment prior to encoding the sound signal segment.

18. The method in claim 1, wherein the modifying includes shortening an end of the sound signal segment by removing silence or background noise of the sound signal segment.

19. The method in claim 1, wherein the modifying includes extending a beginning of the sound signal segment by starting recording or buffering the sound signal segment before a user connection is established or before permission to transmit the sound signal segment is granted.

20. The method in claim 1, wherein the modifying includes extending a beginning of the sound signal segment in a receiver by starting generating background noise prior to generating the sound signal segment.

21. The method in claim 1, wherein the modifying includes extending a beginning of the sound signal segment in a receiver by starting generating a pre-recorded signal or a signal from one or more stored parameters prior to generating the sound signal segment.

22. The method in claim 1, wherein the enhanced perceived interactivity includes reducing a time delay perceived by a person sending the user communication until a response is received by that person.

23. The method in claim 1, wherein the enhanced perceived interactivity is achieved without having to reduce actual user communication connection setup time or actual user communication transmission delay.

24. The method in claim 1, wherein the user communication is a half-duplex communication, a full duplex communication, or a simplex communication.

25. The method in claim 1 applied to radio communications in a digital radio communications system and implemented in a mobile radio, a radio network node, or in both the mobile radio and the radio network node.

26. The method in claim 1, further comprising:
sending sufficient information to one or more entities to permit the one or more entities to make the modification.

27. The method in claim 26, wherein the information is sent using in-band signaling, out-of-band signaling, a marker bit, or a header extension.

28. The method in claim 1, wherein the modifying occurs at a transmitter associated with sending the sound signal.

29. The method in claim 28, wherein the modifying occurs at an encoder in the transmitter.

30. The method in claim 1, wherein the modifying occurs at a receiver associated with receiving the sound signal.

31. The method in claim 30, wherein the modifying occurs at a decoder in the receiver.

32. The method in claim 1, wherein the modifying occurs at a transmitter associated with sending the sound signal and at a receiver associated with receiving the sound signal.

33. The method in claim 1, wherein the modifying occurs at a network server and at a transmitter associated with sending the sound signal or at a receiver associated with receiving the sound signal.

34. Apparatus for enhancing perceived interactivity in a user communication including one or more sound signals, comprising:
sound signal analysis circuitry configured to identify a sound signal in the user communication, determine a sound signal segment based on the identified sound signal, and determine that a length of the sound signal segment in the user communication should be modified, and
modification circuitry configured to modify a part of the sound signal segment to enhance the perceived interactivity in the user communication.

35. The apparatus in claim 34, wherein the sound signal segment is based on a part of the identified sound signal, a modified version of the identified sound signal, or a signal associated with the identified sound signal.

36. The apparatus in claim 34, wherein the sound signal segment includes one or more samples of a part of the sound signal or one or more parameters that describe a part of the sound signal.

37. The apparatus in claim 34, wherein the sound signal includes a speech signal, a period of silence in the user communication, or background noise.

38. The apparatus in claim 37, wherein a speech sound signal may be word, a sentence, or plural sentences.

39. The apparatus in claim 38, wherein the user communication is a push-to-talk (PTT) communication and a speech sound signal in the PTT communication is the sound signal received from initiating a PTT communication to ending the PTT communication.

40. The apparatus in claim 34, wherein the modification circuitry is further configured to modify a length or duration of the sound signal segment.

41. The apparatus in claim 34, wherein the modification circuitry is further configured to remove a portion of the sound signal segment, insert a sound portion into the sound signal segment, or both remove a portion of the sound signal segment and insert a sound portion into the sound signal segment.

42. The apparatus in claim 34, wherein the modification circuitry is further configured to shorten the sound signal segment, lengthen the sound signal segment, or both shorten and lengthen the sound signal segment.

43. The apparatus in claim 34, wherein the modification circuitry is further configured to add sound signal samples, remove sound signal samples, or both add and remove sound signal samples.

44. The apparatus in claim 34, wherein the sound signal is compressed and the modification circuitry is further configured to modify a length of a compressor residual.

45. The apparatus in claim 44, wherein the sound signal is compressed using a linear predictive coding (LPC) algorithm and wherein the modification circuitry is further configured to add LPC residual samples, remove LPC residual samples, or both add and remove LPC residual samples.

46. The apparatus in claim 34, wherein the modification circuitry is further configured to modify a length or duration of silence or background noise in the sound signal segment by adding or removing comfort noise or by doing both.

47. The apparatus in claim 34, wherein the modification circuitry is further configured to modify a length or duration of a sound signal segment generated from a silence descriptor (SID) frame.

48. The apparatus in claim 34, wherein the modification circuitry is further configured to add pitch periods, remove pitch periods, or both add and remove pitch periods.

49. The apparatus in claim 34, wherein the modification circuitry is further configured to achieve the enhanced perceived interactivity without having to reduce actual user communication connection setup time or actual user communication transmission delay.

50. The apparatus in claim 34 applied to radio communications in a digital radio communications system and implemented in a mobile radio, a radio network node, or in both the mobile radio and the radio network node.

51. The apparatus in claim 34, further comprising:
signaling circuitry configured to send sufficient information to one or more entities including the modification circuitry to permit the one or more entities to make the modification.

52. The apparatus in claim 34, wherein the modification circuitry is located in a transmitter for sending the sound signal.

53. The apparatus in claim 52, wherein the modification circuitry is located in an encoder in the transmitter.

54. The apparatus in claim 34, wherein the modification circuitry is located at a receiver for receiving the sound signal.

55. The apparatus in claim 54, wherein the modification circuitry is located in a decoder in the receiver.

56. The apparatus in claim 34, wherein the modification circuitry is located at a transmitter for sending the sound signal and at a receiver for receiving the sound signal.

57. The apparatus in claim 34, wherein the modification circuitry is located at a network server and at a transmitter for sending the sound signal or at a network server and at a receiver associated with receiving the sound signal.

58. Apparatus for enhancing perceived interactivity in a user communication including one or more sound signals, comprising:
means for identifying a sound signal in the user communication;
means for determining a sound signal segment based on the identified sound signal;
means for determining that a length of the sound signal segment in the user communication should be modified; and
means for modifying a part of the sound signal segment to enhance the perceived interactivity in the user communication.

59. The apparatus in claim 58, wherein the sound signal segment is based on a part of the identified sound signal, a modified version of the identified sound signal, or a signal associated with the identified sound signal.

60. The apparatus in claim 58, wherein the sound signal segment includes one or more samples of a part of the sound signal or one or more parameters that describe a part of the sound signal.

61. The apparatus in claim 58, wherein the sound signal includes a speech signal, a period of silence in the user communication, or background noise.

62. The apparatus in claim 58, wherein the user communication is a push-to-talk (PTT) communication and a speech sound signal in the PTT communication is the sound signal received from initiating a PTT communication to ending the PTT communication.

63. The apparatus in claim 58, wherein the means for modifying includes means for modifying a length or duration of the sound signal segment.

64. The apparatus in claim 58, wherein the means for modifying includes means for removing a portion of the sound signal segment, means for inserting a sound portion into the sound signal segment, or means for both removing a portion of the sound signal segment and inserting a sound portion into the sound signal segment.

65. The apparatus in claim 58, wherein the means for modifying includes means for shortening the sound signal segment, means for lengthening the sound signal segment, or means for both shortening and lengthening the sound signal segment.

66. The apparatus in claim 58, wherein the modifying includes means for adding sound signal samples, means for removing sound signal samples, or means for both adding and removing sound signal samples.

67. The apparatus in claim 58, wherein the sound signal is compressed and the means for modifying includes means for modifying a length of a compressor residual.

68. The apparatus in claim 58, wherein the means for modifying includes means for modifying a length or duration of silence or background noise in the sound signal segment by adding or removing comfort noise or by doing both.

69. The apparatus in claim 58, wherein the means for modifying includes means for modifying a length or duration of a sound signal segment generated from a silence descriptor (SID) frame.

70. The apparatus in claim 58, wherein the user communication is a half-duplex communication, a full duplex communication, or a simplex communication.

71. The apparatus in claim 58 applied to radio communications in a digital radio communications system and implemented in a mobile radio, a radio network node, or in both the mobile radio and the radio network node.

72. The apparatus in claim 58, further comprising:
means for sending sufficient information to one or more entities to permit the one or more entities to make the modification.

73. The apparatus in claim 72, wherein the information is sent using in-band signaling, out-of-band signaling, a marker bit, or a header extension.
